(19) United States
(12) Patent Application Publication
(10) Pub. No.: US 2026/0061290 A1
(43) Pub. Date: Mar. 5, 2026

(54) ELECTRONIC APPARATUS AND CONTROL METHOD THEREOF

(71) Applicant: SAMSUNG ELECTRONICS CO., LTD., Suwon-si (KR)

(72) Inventors: Seunghyun CHO, Suwon-si (KR); Suna KIM, Suwon-si (KR); Yohan LEE, Suwon-si (KR); Eunbi CHO, Suwon-si (KR); Jiyoun HAN, Suwon-si (KR)

(73) Assignee: SAMSUNG ELECTRONICS CO., LTD., Suwon-si (KR)

(21) Appl. No.: 19/381,715

(22) Filed: Nov. 6, 2025

Related U.S. Application Data
(63) Continuation of application No. PCT/KR2024/006493, filed on May 13, 2024.

(30) Foreign Application Priority Data
Jun. 7, 2023 (KR) 10-2023-0073120

(51) Int. Cl. A63B 71/06; G06V 10/44; G06V 20/50; G06V 40/16; G06V 40/20

(52) U.S. Cl. CPC A63B 71/0622; G06V 10/44; G06V 20/50; G06V 40/174; G06V 40/23

(57) ABSTRACT

An electronic apparatus includes memory storing at least one instruction; and at least one processor, wherein the at least one instruction, when executed by the at least one processor, individually or collectively, causes the electronic apparatus to obtain an internal image of a space in which the electronic apparatus is located; identify a space size and an object located in the space based on the internal image; identify, based on the space size and the object, a plurality of points including a first point at which a user in exercise is to be located in the space, and a second point at which at least one device for providing feedback information to the user to be located at the first point is to be located in the space; and provide a guide image of the space and the plurality of points in the space.

### CROSS-REFERENCE TO RELATED APPLICATIONS

This application is a by-pass continuation application of International Application No. PCT/KR2024/006493, filed on May 13, 2024, which is based on and claims priority to Korean Patent Application No. 10-2023-0073120, filed on Jun. 7, 2023, in the Korean Intellectual Property Office, the disclosures of which are incorporated by reference herein in their entireties.

### BACKGROUND

### 1. Field

The present disclosure relates to an electronic apparatus and a control method thereof, and more particularly, to an electronic apparatus and a control method thereof for guiding a method for setting at least one device for providing a user with exercise the feedback information, and providing a user with exercise the feedback information based on user personal information and user the exercise information.

### 2. Description of Related Art

As interest in health increases and quality of life improves, people have come to experience and attempt various exercises in their daily lives, and in this process, a concept of personal training optimized for each individual has become generalized.

Various healthcare applications (hereinafter, applications) for guiding the exercise information and exercise routines to individuals have been utilized. Through the healthcare application, a user may learn types of exercises, motions for each exercise, and other the exercise information, and may directly select a desired exercise among the plurality of exercises to create a customized exercise routine.

In addition, various technologies have been developed to monitor the physical condition of an individual and provide information such as heart rate and exercise history to the individual, thereby enabling more efficient and personalized exercise.

### SUMMARY

According to an aspect of the disclosure, an electronic apparatus includes memory storing at least one instruction; and at least one processor, wherein the at least one instruction, when executed by the at least one processor, individually or collectively, causes the electronic apparatus to obtain an internal image of a space in which the electronic apparatus is located; identify a space size and an object located in the space based on the internal image; identify, based on the space size and the object, a plurality of points including a first point at which a user in exercise is to be located in the space, and a second point at which at least one device for providing feedback information to the user to be located at the first point is to be located in the space; and provide a guide image of the space and the plurality of points in the space.

The second point may include at least one of a third point at which a display device is to be located in the space or a fourth point at which a camera is to be located, and the at least one instruction, when executed by the at least one processor, individually or collectively, may cause the electronic apparatus to identify at least one of the third point or the fourth point based on the space size and a location of the first point.

The at least one instruction, when executed by the at least one processor, individually or collectively, may cause the electronic apparatus to identify a posture of the user to be located at the first point; identify a gaze direction of the user based on the posture of the user; and identify, as the third point, a point corresponding to the gaze direction of the user.

The at least one instruction, when executed by the at least one processor, individually or collectively, may cause the electronic apparatus to identify a posture of the user to be located at the first point; and identify, as the fourth point, a point at which an entire body of the user is capable of being captured, based on the space size, the location of the first point, and the posture of the user.

The at least one instruction, when executed by the at least one processor, individually or collectively, may cause the electronic apparatus to identify a size of free space available to the user located at the first point based on the space size, the object located in the space, and the location of the first point; and provide an exercise guide based on the size of the free space.

The at least one instruction, when executed by the at least one processor, individually or collectively, may cause the electronic apparatus to transmit, to the at least one device located at the second point, a control signal for an image capturing operation or an image display operation of the at least one device, based on at least one of the space size, the object, a posture of the user located at the first point, or a gaze direction of the user located at the first point, the image capturing operation including at least one of a capturing angle, a capturing range, a magnification, or a capturing brightness, and the image display operation including at least one of a display angle, a size of content to be displayed, a ratio of regions in the content to be displayed, or a display brightness.

The at least one instruction, when executed by the at least one processor, individually or collectively, may cause the electronic apparatus to transmit, to the at least one device located at the second point, a signal to cause an operation performed by the at least one device to be changed if at least one of a location of the user or a posture of the user in the space changes.

The at least one instruction, when executed by the at least one processor, individually or collectively, may cause the electronic apparatus to obtain an image of the user in exercise and information on the exercise performed by the user; identify a posture of the user based on the image of the user; identify a difference between an exercise posture included in exercise information and the posture of the user; and provide exercise guide information based on the difference.

The at least one instruction, when executed by the at least one processor, individually or collectively, may cause the electronic apparatus to obtain an exercise list excluding the exercise if the difference is greater than or equal to a predetermined value.

The at least one instruction, when executed by the at least one processor, individually or collectively, may cause the electronic apparatus to obtain an image of the user in exercise and information on the exercise performed by the user; identify a facial expression of the user based on the image of the user; and provide exercise guide information based on the information on the exercise and the facial expression.

The at least one instruction, when executed by the at least one processor, individually or collectively, may cause the electronic apparatus to identify an emotion of the user based on the facial expression; and obtain an exercise list excluding the exercise if the emotion is a negative emotion.

The at least one instruction, when executed by the at least one processor, individually or collectively, may cause the electronic apparatus to identify a heart rate of the user in exercise for a predetermined time; and obtain an exercise list excluding the exercise if a difference between the heart rate during the predetermined time and a reference heart rate for the exercise is greater than or equal to a predetermined value.

The at least one instruction, when executed by the at least one processor, individually or collectively, may cause the electronic apparatus to identify exercise information skipped by the user; and obtain an exercise list excluding the exercise.

The at least one instruction, when executed by the at least one processor, individually or collectively, may cause the electronic apparatus to identify physical information of the user and exercise information of the user; and provide exercise guide information based on the physical information and the exercise information; identify at least one of a main description or a main body part in a video if the exercise guide information is provided as the video; and display an animation effect emphasizing information on at least one of the main description or the main body part.

According to an aspect of the disclosure, a control method of an electronic apparatus includes obtaining an internal image of a space in which the electronic apparatus is located; identifying a space size and an object located in the space based on the internal image; identifying, based on the space size and the object, a plurality of points including a first point at which a user in exercise is to be located in the space and a second point at which at least one device for providing feedback information to the user to be located at the first point is to be located in the space; and providing a guide image of the space and the plurality of points in the space.

The second point may include at least one of a third point at which a display device is to be located in the space or a fourth point at which a camera is to be located, and the identifying the plurality of points may include identifying at least one of the third point or the fourth point based on the space size and a location of the first point.

The identifying the plurality of points may include identifying a posture of the user to be located at the first point; identifying a gaze direction of the user based on the posture of the user; and identifying, as the third point, a point corresponding to the gaze direction of the user.

The identifying the plurality of points may include identifying a posture of the user to be located at the first point; and identifying, as the fourth point, a point at which an entire body of the user is capable of being captured, based on the space size, the location of the first point, and the posture of the user.

The control method may further include identifying a size of free space available to the user located at the first point based on the space size, the object located in the space, and the location of the first point; and providing an exercise guide based on the size of the free space.

According to an aspect of the disclosure, a non-transitory computer-readable recording medium having at least one instruction recorded thereon, that, when executed by at least one processor individually or collectively, causes the at least one processor to obtain an internal image of a space in which an electronic apparatus is located; identify a space size and an object located in the space based on the internal image; identify, based on the space size and the object, a plurality of points including a first point at which a user in exercise is to be located in the space, and a second point at which at least one device for providing feedback information to the user to be located at the first point is to be located in the space; and provide a guide image of the space and the plurality of points in the space.

### BRIEF DESCRIPTION OF THE DRAWINGS

The above and other aspects, features, and advantages of certain embodiments of the present disclosure are more apparent from the following description taken in conjunction with the accompanying drawings, in which:

FIG. 1 is a block diagram illustrating a configuration of an electronic apparatus according to an embodiment of the present disclosure;

FIG. 2 is a diagram illustrating a space in which a user is to exercise and an object located in the space according to an embodiment of the present disclosure;

FIG. 3 is a diagram illustrating a second point at which at least one device for providing the feedback information to the user exercising in the space may be disposed according to an embodiment of the present disclosure;

FIG. 4A is a diagram illustrating a user posture and a user gaze if the user is located at a first point in the space and exercises according to an embodiment of the present disclosure;

FIG. 4B is a diagram illustrating a user posture and a user gaze if the user is located at the first point in the space and exercises according to an embodiment of the present disclosure;

FIG. 4C is a diagram illustrating a user posture and a user gaze if the user is located at the first point in the space and exercises according to an embodiment of the present disclosure;

FIG. 5A is a diagram illustrating a method for displaying the feedback information based on posture information or gaze information of the user exercising according to an embodiment of the present disclosure;

FIG. 5B is a diagram illustrating a method for displaying the feedback information based on posture information or gaze information of the user exercising according to an embodiment of the present disclosure;

FIG. 5C is a diagram illustrating a method for displaying the feedback information based on posture information or gaze information of the user exercising according to an embodiment of the present disclosure;

FIG. 6A is a diagram illustrating an operation in which a device including both a camera and a display acquires an image by photographing a user through the camera according to an embodiment of the present disclosure;

FIG. 6B is a diagram illustrating an operation in which a device including both a camera and a display provides the feedback information to the user through the display according to an embodiment of the present disclosure;

FIG. 7 is a diagram illustrating a method in which the electronic apparatus provides the user with an exercise list based on at least one of the posture accuracy, expression, heart rate, or input history of the user according to an embodiment of the present disclosure;

FIG. 8 is a flowchart illustrating an operation in which the electronic apparatus provides the user with a customized exercise list based on user posture accuracy according to an embodiment of the present disclosure;

FIG. 9 is a diagram illustrating an operation in which the electronic apparatus identifies user posture accuracy information by identifying a difference between an exercise posture included in the exercise information and an identified user posture according to an embodiment of the present disclosure;

FIG. 10 is a flowchart illustrating an operation in which the electronic apparatus provides the user with a customized exercise list based on a user expression according to an embodiment of the present disclosure;

FIG. 11 is a diagram illustrating an operation in which the electronic apparatus identifies the user expression according to an embodiment of the present disclosure;

FIG. 12 is a diagram illustrating an operation in which the electronic apparatus provides an animation effect emphasizing information on at least one of a main description or a main body part in an image according to an embodiment of the present disclosure;

FIG. 13A is a diagram illustrating an operation in which the electronic apparatus provides the exercise guide information based on at least one of a user motion or the user gaze according to an embodiment of the present disclosure;

FIG. 13B is a diagram illustrating an operation in which the electronic apparatus provides the exercise guide information based on at least one of a user motion or the user gaze according to an embodiment of the present disclosure;

FIG. 14 is a sequence diagram illustrating a system including a first electronic apparatus and a second electronic apparatus for providing the user with the exercise the feedback information according to an embodiment of the present disclosure; and

FIG. 15 is a flowchart illustrating an operation of an electronic apparatus according to an embodiment of the present disclosure.

### DETAILED DESCRIPTION

The embodiments described in the disclosure, and the configurations shown in the drawings, are only examples of embodiments, and various modifications may be made without departing from the scope and spirit of the disclosure.

Throughout the accompanying drawings, similar components are denoted by similar reference numerals.

In describing the present disclosure, omitted is a detailed description of a case where it is decided that a detailed description of the known functions or configurations related to the present disclosure may unnecessarily obscure the gist of the present disclosure.

In addition, the following embodiment may be modified in several different forms, and the scope and spirit of the present disclosure are not limited to the following embodiments. Rather, these embodiments make the disclosure thorough and complete, and are provided to completely convey the spirit of the disclosure to those skilled in the art.

Terms used in the disclosure are used only to describe the specific embodiments rather than limit the scope of the disclosure. A term of a singular number may include its plural number unless explicitly indicated otherwise in the context.

In the present disclosure, the expression such as “have”, “may have”, “include”, or “may include”, indicates the presence of a corresponding feature (e.g., a numerical value, a function, an operation, or a component such as a part), and does not exclude the presence of an additional feature.

In the present disclosure, the expression such as “A or B”, “least one of A and/or B”, or “one or more of A and/or B” may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

The expressions such as “first” and “second”, used in the present disclosure, may indicate various components regardless of the sequence and/or importance of the components. These expressions are only used to distinguish one component and another component from each other, and do not limit the corresponding components.

If any component (e.g., a first component) is mentioned to be “(operatively or communicatively) coupled with/to” or “connected to” another component (e.g., a second component), it should be understood that the any component is directly coupled to another component or may be coupled to another component through yet another component (e.g., a third component).

On the other hand, if any component (e.g., the first component) is mentioned to be “directly coupled with/to” or “directly connected to” another component (e.g., the second component), it should be understood that yet another component (e.g., the third component) is not present between any component and another component.

An expression such as “configured (or set) to”, used in the present disclosure, may be replaced by an expression such as “suitable for”, “having the capacity to”, “designed to”, “adapted to”, “made to”, or “capable of”, depending on a context. The expression “configured (or set) to” does not necessarily indicate “specifically designed to” in terms of hardware.

Instead, the expression “a device configured to”, in any context, may indicate that the device may “perform˜” together with another device or component. For example, a “processor configured (or set) to perform A, B, and C” may indicate a dedicated processor (e.g., an embedded processor) that may perform the corresponding operations or a generic-purpose processor (e.g., a central processing unit (CPU) or an application processor) that may perform the corresponding operations by executing one or more software programs stored in a memory device.

In the embodiments, a “module” or a “part” may perform at least one function or operation, and be implemented by hardware or software or be implemented by a combination of hardware and software. In addition, a plurality of “modules” or a plurality of “parts” may be integrated in at least one module and be implemented by the processor except for a “module” or a “part” that needs to be implemented by specific hardware.

Meanwhile, the various elements and areas in the drawings are schematically shown. Therefore, the spirit of the disclosure is not limited by relative sizes or intervals shown in the accompanying drawings.

Hereinafter, an embodiment of the disclosure is described in detail with reference to the accompanying drawings so that those skilled in the art to which the disclosure pertains may easily practice the disclosure.

An electronic apparatus according to the present disclosure may guide a method for setting at least one device for providing a user with exercise the feedback information, and provide the user with the exercise the feedback information based on user personal information and user the exercise information.

The electronic apparatus may include, for example, a smartphone, a tablet personal computer (PC), a wearable device, a display device, or the like, and is not limited thereto.

The electronic apparatus according to the present disclosure may be implemented as a single electronic apparatus, or may be implemented as a plurality of electronic apparatuses connected to each other in a wireless communication manner.

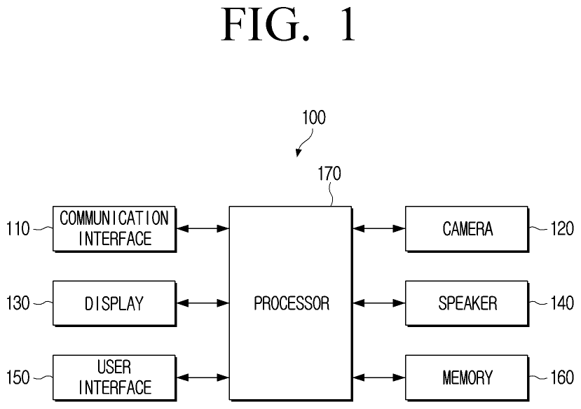

FIG. 1 is a block diagram illustrating a configuration of an electronic apparatus according to an embodiment of the present disclosure.

Referring to FIG. 1, the electronic apparatus 100 may include a communication interface 110, a camera 120, a display 130, a speaker 140, a user interface 150, a memory 160, and at least one processor 170 (hereinafter, the processor 170).

However, the configuration of the electronic apparatus 100 is not limited to the above-described apparatus configuration, and other apparatus configuration for performing an operation of the electronic apparatus 100 may be included.

The communication interface 110 may include a wireless communication interface, a wired communication interface, or an input interface.

The wireless communication interface may communicate with various external devices by using wireless communication technology or mobile communication technology. Such wireless communication technologies may include, for example, Bluetooth, Bluetooth low energy, controller area network (CAN) communication, wireless-fidelity (Wi-Fi), Wi-Fi Direct, ultrawide band (UWB) communication, Zigbee, infrared Data Association (IrDA) communication, or near field communication (NFC). The mobile communication technology may include third generation partnership project (3GPP), Wi-Max, long term evolution (LTE), or fifth generation (5G).

The wireless communication interface may be implemented by using an antenna, a communication chip, or a substrate capable of transmitting electromagnetic waves to the outside or receiving electromagnetic waves transmitted from the outside.

The wired communication interface may communicate with various external devices based on a wired communication network. Here, the wired communication network may be implemented by using, for example, a physical cable such as a pair cable, a coaxial cable, an optical fiber cable, or an Ethernet cable.

At least one of the wireless communication interface or the wired communication interface may be included according to an embodiment. Accordingly, the electronic apparatus 100 may include only the wireless communication interface or may include only the wired communication interface. In addition, the electronic apparatus 100 may include an integrated communication interface supporting both wireless connection through the wireless communication interface and wired connection through the wired communication interface.

The electronic apparatus 100 is not limited to including one communication interface 110 that performs one type of communication connection, and may include a plurality of communication interfaces 100 that perform various types of communication connections.

The processor 170 may perform the communication connection with an external device or a server through the communication interface 110 to transmit or acquire control signals for an image capture or the display 130, exercise information (e.g., exercise type, exercise goal, exercise posture, exercise description, exercise part, exercise precautions, or risk of injury in exercise), or user personal information (such as the height, weight, gender, or age group of a user).

The processor 170 may perform the communication connection with the external device or the server through the communication interface 110 to transmit or acquire images, videos, audio, or the like.

In detail, the processor 170 may perform the communication connection with the external device or the server through the communication interface 110 to transmit or acquire information on an internal image of a space in which the electronic apparatus 100 is located, information on a space size, information on an object located in the space, information on a first point at which the user in exercise is to be located in the space, information on a second point at which at least one device for providing feedback information to the user is to be located in the space, and guide information on the space and the points in the space.

Here, the feedback information may be information on the exercise posture accuracy, the exercise information, or physical condition of the user, is not limited thereto, and may be various exercise-related information that the user may refer to during exercise.

Signals or information transmitted or acquired by the processor 170 through the communication interface 110 in performing the communication connection with the external device or the server are not limited to the description provided above, and the processor 170 may transmit or acquire various signals or information required for performing operations.

The camera 120 may capture still images and moving images. According to an embodiment, the camera 120 may include at least one lens, an image sensor, an image signal processor 170, or a flash.

The processor 170 may acquire an image by capturing images of the space in which the electronic apparatus 100 is located, at least one object located in the space, the user in exercise, or the like through the camera 120.

The display 130 may include various types of display panels such as a liquid crystal display (LCD) panel, an organic light-emitting diode (OLED) panel, an active-matrix organic light-emitting diode (AM-OLED), a liquid crystal on silicon (LCoS), a quantum dot light-emitting diodes (QLED), a digital light processing (DLP), a plasma display panel (PDP), an inorganic LED panel, or a micro LED panel, and is not limited thereto. Meanwhile, the display 130 may be included in a touchscreen together with a touch panel or may be formed as a flexible panel.

The display 130 may be implemented in a two-dimensional (2D) shape such as a square or rectangle, is not limited thereto, and may be implemented in various shapes such as a circle or polygon, or a three-dimensional (3D) stereoscopic shape.

The processor 170 may control the display 130 to output the internal image of the space, the information on the space size, the information on the object located in the space, the information on the first point at which the user in exercise is to be located in the space, the information on the second point at which at least one device for providing the feedback information to the user to be located at the first point is to be located in the space, a guide image of the space and the points in the space, or the like.

In addition, the processor 170 may control the display 130 to output the exercise guide information, the exercise information (e.g., exercise type, exercise goal, exercise posture, exercise description, exercise part, exercise precautions, and risk of injury in exercise), the user personal information (such as the height, weight, gender, or age group of the user), or the like.

The processor 170 may control the display 130 to output the exercise posture, emotion, heart rate, or exercise history information of the user.

However, the present disclosure is not limited thereto, and the processor 170 may control the display 130 to output various graphic user interfaces (GUIs), images, or videos for providing the user with the exercise information or the feedback information.

The speaker 140 may include a tweeter for reproducing high-frequency sounds, a mid-range speaker for reproducing mid-frequency sounds, a woofer for reproducing low-frequency sounds, a subwoofer for reproducing ultra-low-frequency sounds, an enclosure for controlling resonance, a crossover network for dividing frequencies of electric signals input to the speaker 140 for each band, or the like.

The speaker 140 may output audio signals to the outside of the electronic apparatus 100. The speaker 140 may output multimedia reproduction, recording reproduction, various alert sounds, voice messages, or the like. The electronic apparatus 100 may include an audio output device such as the speaker 140, or may include an output device such as an audio output terminal. In particular, the speaker 140 may provide information acquired, information processed/produced based on the acquired information, a response result to a user voice, an operation result, or the like in the form of sound.

The processor 170 may control the speaker 140 to output the information on the first point at which the user in exercise is to be located in the space, the information on the second point at which at least one device for providing the feedback information to the user to be located at the first point is to be located in the space, the exercise guide information, the exercise information (e.g., exercise type, exercise goal, exercise posture, exercise description, exercise part, exercise precautions, and risk of injury in exercise), the user personal information (such as the height, weight, gender, or age group of the user) or the like.

The processor 170 may control the speaker 140 to output the exercise posture, emotion, heart rate, or exercise history information of the user.

However, the present disclosure is not limited thereto, and the processor 170 may control the speaker 140 to output various sounds or audio for providing the user with the exercise information or the feedback information.

The user interface 150 may include a button, a lever, a switch, a touch-type interface, or the like, and the touch-type interface may be implemented in a manner of receiving a user touch input on a screen of the display 130.

If the user interface 150 is the touch-type interface that receives the user touch input on the screen of the display 130, the processor 170 may receive the user input through a GUI displayed on the display 130.

The processor 170 may receive the user input through the user interface 150. In detail, the processor 170 may receive the user input for controlling the camera 120 or the display 130 included in the electronic apparatus 100 or the external device through the user interface 150.

The memory 160 may store various programs or data temporarily or permanently, and deliver stored information to the processor 170 according to a call of the processor 170. In addition, the memory 160 may store various information required for operations, processing, or control operations of the processor 170 in an electronic format.

The memory 160 may include, for example, at least one of a main memory or an auxiliary memory. The main memory may be implemented by using a semiconductor storage medium such as a read-only memory (ROM) and/or a random access memory (RAM). The ROM may include, for example, a general ROM, an EPROM (Erasable Programmable ROM), an erasable and programmable ROM (EPROM), and/or a mask ROM. The RAM may include, for example, a dynamic RAM (DRAM) and/or a static RAM (SRAM). The auxiliary memory may be implemented by using at least one storage medium capable of permanently or semi-permanently storing data, such as a flash memory device, a secure digital (SD) card, a solid state drive (SSD), a hard disk drive (HDD), a magnetic drum, a compact disc (CD), a digital versatile disk (DVD), an optical medium such as a laser disc, a magnetic tape, a magneto-optical disc, and/or a floppy disk.

The memory 160 may control the display 130 to output the internal image of the space, the information on the space size, the information on the object located in the space, the information on the first point at which the user in exercise is to be located in the space, the information on the second point at which at least one device for providing the feedback information to the user to be located at the first point is to be located in the space, the guide image of the space and the points in the space, or the like.

In addition, the memory 160 may control the display 130 to output the exercise guide information, the exercise information (e.g., exercise type, exercise goal, exercise posture, exercise description, exercise part, exercise precautions, and risk of injury in exercise), the user personal information (such as the height, weight, gender, or age group of the user), or the like.

The memory 160 may store the exercise posture, emotion, heart rate, or exercise history information of the user.

However, the present disclosure is not limited thereto, and the memory 160 may store various information associated with performing an operation of the electronic apparatus 100.

The processor 170 may control overall operations of the electronic apparatus 100. In detail, the processor 170 may be connected to the configuration of the electronic apparatus 100 including the memory 160 as described above, and control the overall operations of the electronic apparatus 100 by executing at least one instruction stored in the memory 160 as described above. In particular, the processor 170 may be implemented as one processor 170, or may be implemented as a plurality of processors 170.

The processor 170 may be implemented in various ways. For example, at least one processor 170 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 170 may control one or any combination of other components of the electronic apparatus 100, and may perform operations related to communication or data processing. At least one processor 170 may execute at least one program or instruction stored in the memory 160. For example, at least one processor 170 may perform a method according to an embodiment of the present disclosure by executing at least one instruction stored in the memory 160.

If the method according to an embodiment of the present disclosure includes a plurality of operations, the plurality of operations may be performed by one processor 170, or may be performed by the plurality of processors 170. For example, if a first operation, a second operation, and a third operation are performed by the method according to an embodiment, all of the first operation, the second operation, and the third operation may be performed by a first processor 170, or the first operation and the second operation may be performed by a first processor 170 (i.e., a general-purpose processor 170) and the third operation may be performed by a second processor 170 (i.e., an artificial intelligence-specific processor).

At least one processor 170 may be implemented as a single-core processor 170 including one core, or may be implemented as at least one multi-core processor 170 including a plurality of cores (i.e., homogeneous multiple cores or heterogeneous multiple cores). If at least one processor 170 is implemented as the multi-core processor 170, each of the multiple cores included in the multi-core processor 170 may include an internal memory 160 of the processor 170 such as an on-chip memory 160, and a common cache shared by the multiple cores may be included in the multi-core processor 170. In addition, each of the multiple cores included in the multi-core processor 170 (or some of the multiple cores) may independently read and perform program instructions for implementing the method according to an embodiment of the present disclosure, or all (or some) of the multiple cores may be linked to read and perform program instructions for implementing the method according to an embodiment of the present disclosure.

If the method according to an embodiment of the present disclosure includes a plurality of operations, the plurality of operations may be performed by one core among the multiple cores included in the multi-core processor 170, or may be performed by the multiple cores. For example, if a first operation, a second operation, and a third operation are performed by the method according to an embodiment, all of the first operation, the second operation, and the third operation may be performed by a first core included in the multi-core processor 170, or the first operation and the second operation may be performed by the first core included in the multi-core processor 170 and the third operation may be performed by a second core included in the multi-core processor 170.

In embodiments of the present disclosure, the processor 170 may indicate a system-on-chip (SoC) integrating at least one processor and other electronic components, the single-core processor, the multi-core processor, or a core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the present disclosure are not limited thereto.

The processor 170 may acquire the internal image of the space in which the electronic apparatus 100 is located. The processor 170 may identify the space size and the object located in the space based on the acquired image. Here, the object may be an exercise device, furniture, or an electronic device located in the space, and is not limited thereto.

The processor 170 may identify, based on the identified space size and the identified object, the first point at which the user in exercise is to be located in the space and the second point at which at least one device for providing the feedback information to the user to be located at the first point is to be located in the space.

Here, the second point may include at least one of a third point at which a display device is to be located in the space or a fourth point at which the camera 120 is to be located, and the processor 170 may identify at least one of the third point or the fourth point based on the identified space size and a location of the identified first point.

In addition, the processor 170 may provide an exercise guide for suggesting the number of cameras 120 to be located at the third point or the number of display devices to be located at the fourth point, based on the exercise information and user personal information.

The processor 170 may provide the guide image of the identified space and the points in the identified space.

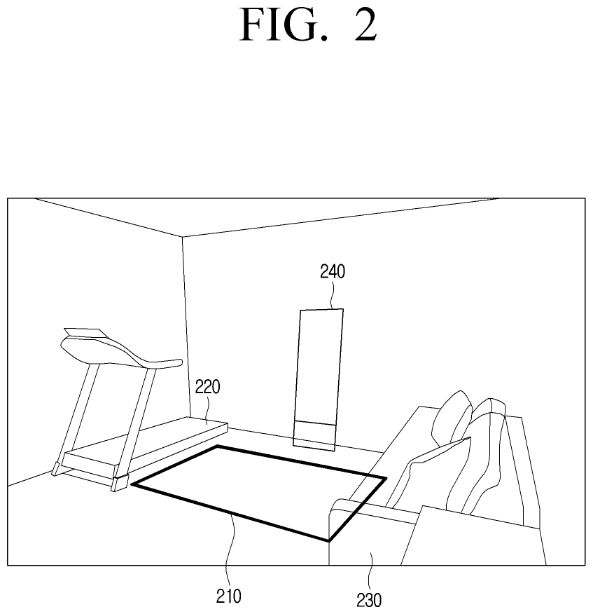

A more specific control operation of the processor 170 for the electronic apparatus 100 is described with reference to FIGS. 2 through 13.

The processor 170 may acquire the internal image of the space in which the electronic apparatus 100 is located. Here, the processor 170 may control the display 130 to output at least one GUI together with an image acquired by applying augmented reality (AR) to an image acquired through the camera 120.

The processor 170 may identify the space size and the object located in the space based on the acquired image. In addition, the processor 170 may acquire the information on at least one object located in the space by inputting the internal image of the space into a neural network model for object identification.

FIG. 2 is a diagram illustrating a space in which a user is to exercise and an object located in the space according to an embodiment of the present disclosure.

Referring to FIG. 2, the processor 170 may identify at least one object such as a mat 210, an exercise device 220, furniture 230, and a mirror 240 located in the space in which the user is to exercise. However, at least one object located in the space is not limited thereto, and may include various exercise devices, furniture, and electronic devices.

The processor 170 may identify the first point at which the user in exercise is to be located in the space and the second point at which at least one device for providing the feedback information to the user to be located at the first point is to be located in the space, based on the identified space size and the identified object.

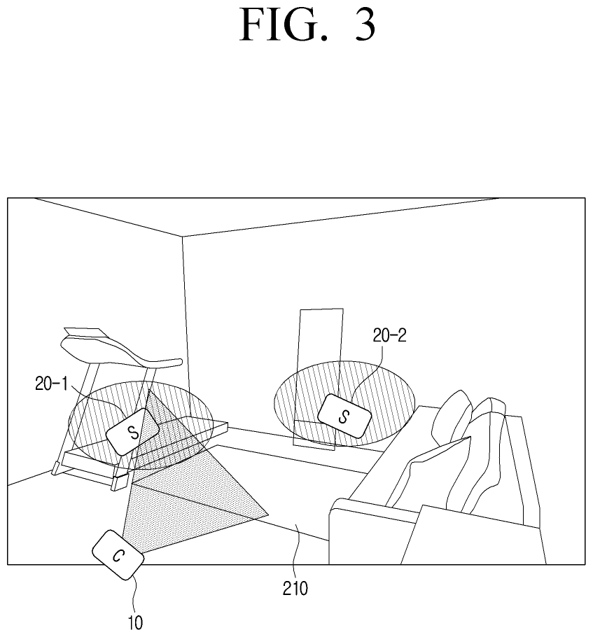

FIG. 3 is a diagram illustrating the second point at which at least one device for providing the feedback information to the user exercising in the space may be disposed according to an embodiment of the present disclosure.

Referring to FIG. 3, the processor 170 may identify the first point at which the user in exercise is to be located in the space as a point at which the mat 210 is located, based on the identified space size and the identified object.

However, the present disclosure is not limited thereto, and the processor 170 may identify an empty space in which the user may be located without the object being located on the acquired image as the first point.

The processor 170 may identify the second point at which at least one device for providing the feedback information to the user to be located at the first point is to be located in the space, based on the identified space size and the identified object.

Here, the second point may include at least one of a third point 20-1 or 20-2 at which the display device is to be located in the space or a fourth point 10 at which the camera 120 is to be located, and the processor 170 may identify at least one of the third point 20-1 or 20-2 and the fourth point 10 based on the identified space size and the location of the identified first point.

The display device may be a beam projector, a tablet PC, a wearable device, or a smartphone, is not limited thereto, and may be various electronic apparatuses 100 capable of outputting visual content by including the display 130.

The camera 120 may be the camera 120, or the electronic apparatus 100 including the camera 120, such as a smartphone, a tablet PC, or a wearable device, is not limited thereto, and may be various electronic apparatuses 100 capable of acquiring an image by capturing the image through the camera 120.

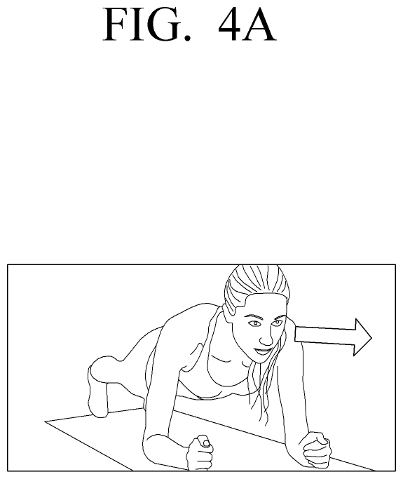

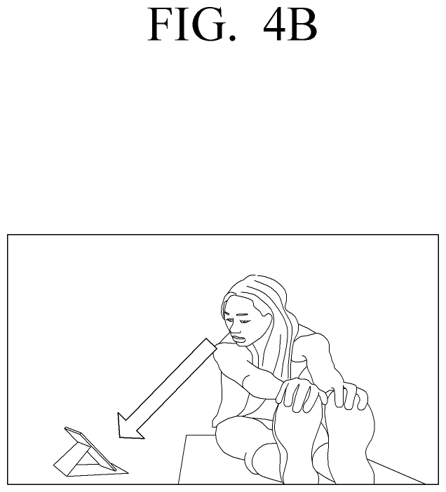

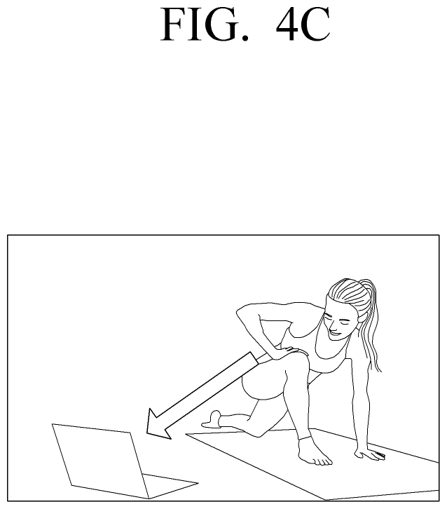

FIGS. 4A, 4B, and 4C are diagrams illustrating a user posture and a user gaze if the user is located at the first point in the space and exercises according to an embodiment of the present disclosure.

Referring to FIG. 4A, the processor 170 may identify that the posture of the user located at the first point is in a posture in which the user is lying down and gazes forward, and identify a user gaze direction is directed forward based on the identified user posture.

Referring to FIG. 4B, the processor 170 may identify that the user located at the first point is in a posture in which the user sits with legs stretched forward and gazes forward or to the side of the user, and identify that the user gaze direction is directed forward or to the side of the user based on the identified user posture.

Referring to FIG. 4C, the processor 170 may identify that the user located at the first point is in a posture in which the user crouches with one foot on a floor and the other leg stretched backward, and identify that the user gaze direction is directed forward or to the side of the user based on the identified user posture.

The processor 170 may identify a point corresponding to the identified user gaze direction as the third point 20 at which the display device for outputting an image or a video providing the feedback information to the user is to be located.

In addition, the processor 170 may identify the posture of the user to be located at the first point, and identify, as a fourth point 10, a point at which the camera 120 or a device including the camera 120 is to be located to capture an entire body of the user, based on the space size, the location of the first point, and the identified user posture.

The processor 170 may provide the guide image of the identified space and the points in the identified space.

In detail, the processor 170 may identify a size of the free space available to the user located at the first point based on the space size, the object located in the space, and the location of the first point, and provide the exercise guide based on the size of the identified free space.

For example, if the size of the identified free space is greater than or equal to a predetermined value, the processor 170 may control the display 130 or the speaker 140 to output an exercise guide suggesting exercises such as jumping jacks or jump rope that utilize a relatively large space.

On the contrary, if the size of the identified free space is less than the predetermined value, the processor 170 may control the display 130 or the speaker 140 to output an exercise guide suggesting exercises such as sit-ups or planks that utilize a relatively small space.

In an embodiment, the processor 170 may transmit a control signal for either an image capturing method of at least one device or a display method of an image or a video on the display 130 to at least one device located at the second point through the communication interface 110, based on at least one of the space size, the identified object, the posture of the user located at the first point, or the gaze direction of the user located at the first point.

In detail, the processor 170 may transmit a control signal for the display method of an image or a video on the display 130 to a device located at the third point 20 at which the display device for providing the feedback information to the user is to be located among the second points, through the communication interface 110, based on at least one of the space size, the identified object, the posture of the user located at the first point, or the gaze direction of the user located at the first point.

Here, the display method of an image or a video on the display 130 may include at least one of an angle of the display 130, a size of content displayed on the display 130, a ratio of each region in content displayed on the display 130, or a brightness of the display 130.

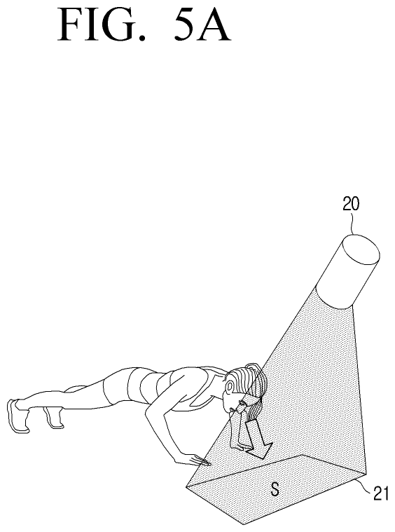

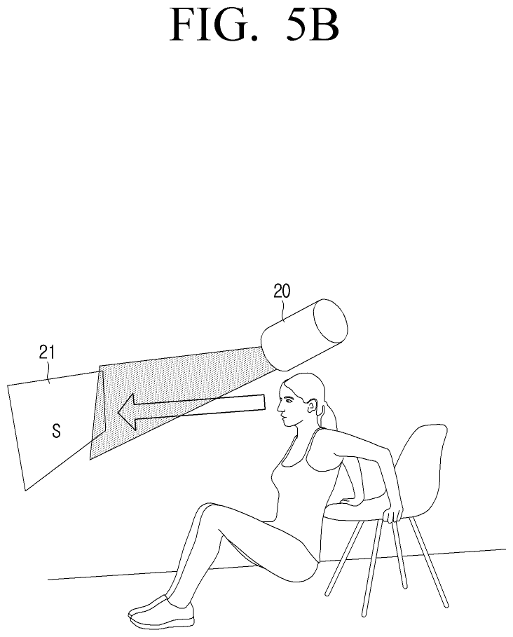

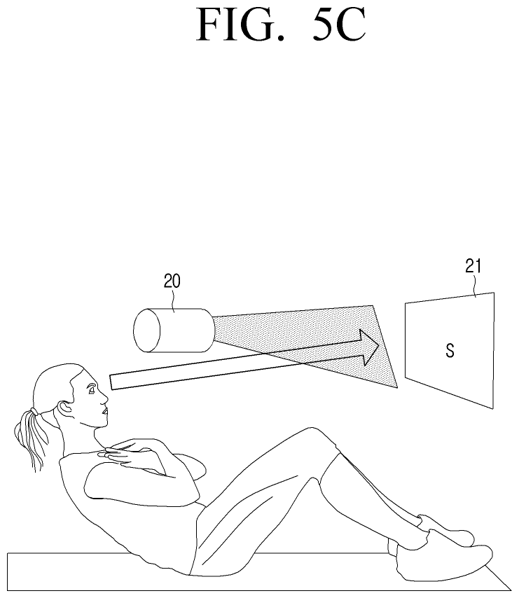

FIGS. 5A, 5B, and 5C are diagrams illustrating a method for displaying the feedback information based on the posture information or gaze information of the user exercising according to an embodiment of the present disclosure.

Referring to FIG. 5A, if the user located at the first point takes a plank posture and the user gaze direction is directed forward or downward, the processor 170 may perform the communication connection with the display device located at the third point 20, and transmit a control signal to the display device through the communication interface 110 to display the feedback information on a display screen 21 at an angle and size most convenient for the user exercising at the first point to view.

Referring to FIG. 5B, if the user located at the first point supports arms on a chair and performs an exercise of moving the body up and down while the user gaze direction is directed forward, the processor 170 may perform the communication connection with the display device located at the third point 20, and transmit a control signal to the display device through the communication interface 110 to display 21 the feedback information on the display screen 21 at an angle and size most convenient for the user exercising at the first point to view.

Referring to FIG. 5C, if the user located at the first point takes the sit-up posture and the user gaze direction is directed forward or upward, the processor 170 may perform the communication connection with the display device located at the third point 20, and transmit a control signal to the display device through the communication interface 110 to display the feedback information on the display screen 21 at an angle and size most convenient for the user exercising at the first point to view.

Here, if the feedback information is displayed on the display 130 by a beam projector, the processor 170 may transmit a signal to the display device to display the feedback information or content on the display 130 by correcting at least one of an angle of the feedback information or content displayed on the display 130, a size of the feedback information or content displayed on the display 130, and a ratio of each region in the feedback information or content displayed on the display 130, based on the shape or width of a space onto which the beam is projected, and the presence, size, or shape of the object, or the like.

In addition, the processor 170 may transmit the control signal for the image capturing method to the device located at the fourth point 10 at which the camera 120 is to be located to capture the user body among the second points through the communication interface 110, based on at least one of the space size, the identified object, the posture of the user located at the first point, or the gaze direction of the user located at the first point.

Here, the image capturing method may include at least one of a capturing angle, a capturing range, a magnification, or a capturing brightness.

According to an embodiment, the device located at the second point may be a device including both the display 130 and the camera 120, and may acquire an image by capturing the user image through the camera 120 and simultaneously display the feedback information on the display 130 based on the acquired user image.

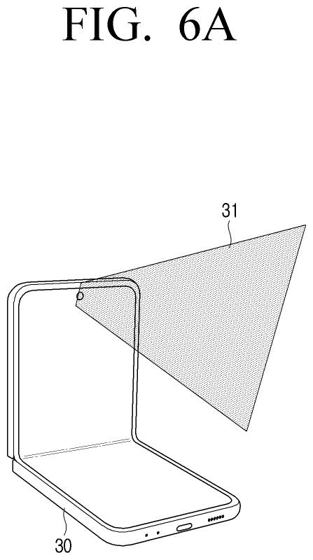

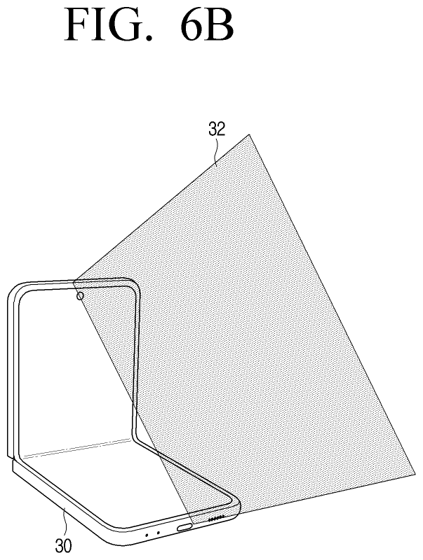

FIG. 6A is a diagram illustrating an operation in which the device including both the camera 120 and the display 130 acquires an image by capturing the user image through the camera 120 according to an embodiment of the present disclosure.

Referring to FIG. 6A, the processor 170 may transmit, to a device 30 located at the second point, a control signal for an image capturing method of the camera 120 for allowing the device 30 located at the second point to acquire an image by capturing the user image through the camera 120, through the communication interface 110, based on at least one of the space size, the identified object, the posture of the user located at the first point, or the gaze direction of the user located at the first point.

FIG. 6B is a diagram illustrating an operation in which the device including both the camera 120 and the display 130 provides the feedback information to the user through the display 130 according to an embodiment of the present disclosure.

Referring to FIG. 6B, the processor 170 may transmit, to the device 30 located at the second point, a control signal for a display method of the display 130 for allowing the device 30 located at the second point to output the feedback information by controlling the display 130, through the communication interface 110, based on at least one of the space size, the identified object, the posture of the user located at the first point, or the gaze direction of the user located at the first point.

However, the present disclosure is not limited thereto, and if the electronic apparatus 100 is the device located at the second point and including both the camera 120 and the display 130, the processor 170 may identify the image capturing method or image display method of at least one device by using at least one device located at the second point, based on at least one of the space size, the identified object, the posture of the user located at the first point, or the gaze direction of the user located at the first point. The processor 170 can acquire an image by capturing the user image by using the identified capturing method, and provide the feedback information to the user by using the identified display method.

According to an embodiment, the processor 170 may transmit, to at least one device located at the second point, a signal to cause an operation performed by at least one device located at the second point to be changed if at least one of the user location or the user posture in the space changes.

In detail, if at least one of the user location or the user posture changes while the device located at the second point performs an operation of displaying the feedback information, the processor 170 may transmit, to the device located at the second point through the communication interface 110, a control signal to cause the device performing the display operation to perform an operation for acquiring an image by capturing the user image through the camera 120.

On the contrary, if at least one of the user location or the user posture changes while the device located at the second point performs an operation of acquiring an image by capturing the user image through the camera 120, the processor 170 may transmit, to the device located at the second point through the communication interface 110, a control signal to cause the device performing the image acquiring operation through the camera 120 to perform a display operation of outputting the feedback information.

According to an embodiment, the processor 170 may provide the user with the exercise list based on a plurality of user exercise monitoring information.

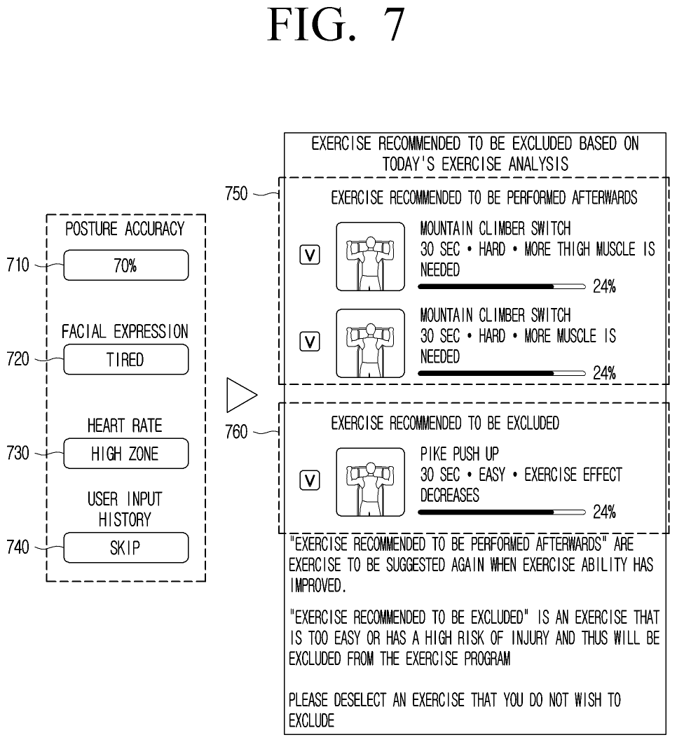

FIG. 7 is a diagram illustrating a method in which the electronic apparatus 100 provides the user with the exercise list based on at least one of the posture accuracy, expression, heart rate, or input history of the user according to an embodiment of the present disclosure.

Referring to FIG. 7, the processor 170 may provide the user with the recommended exercise list based on at least one of identified user posture accuracy 710, an identified user facial expression 720, an identified user heart rate 730, or an identified user input history 740.

Here, the processor 170 may identify an exercise 750 recommended to be performed afterwards and an exercise 760 recommended to be excluded based on at least one of the identified user posture accuracy 710, the identified user facial expression 720, the identified user heart rate 730, or the identified user input history 740. The processor 170 may provide the user with the exercise list excluding the exercise 750 recommended to be performed afterwards and the exercise 760 recommended to be excluded. Here, the exercise 750 recommended to be performed afterwards and the exercise 760 recommended to be excluded may be exercises that place a relatively high burden on muscles or joints, are of high difficulty, or have a high risk of injury.

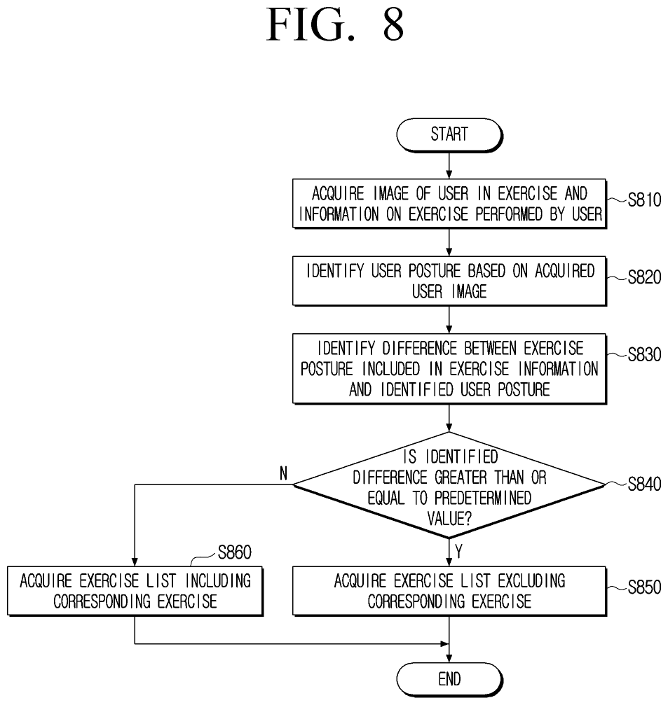

FIG. 8 is a flowchart illustrating an operation in which the electronic apparatus 100 provides the user with a customized exercise list based on the user posture accuracy according to an embodiment of the present disclosure.

Referring to FIG. 8, the processor 170 may acquire an image of the user in exercise and the information on the exercise performed by the user (S810). The processor 170 may identify the user posture based on the acquired user image (S820). The user posture may be any of various exercise postures such as the plank posture, the sit-up posture, or the jumping jack posture.

The processor 170 may identify a difference between the exercise posture included in the exercise information and the identified user posture (S830). The processor 170 may provide the exercise guide information based on the identified difference.

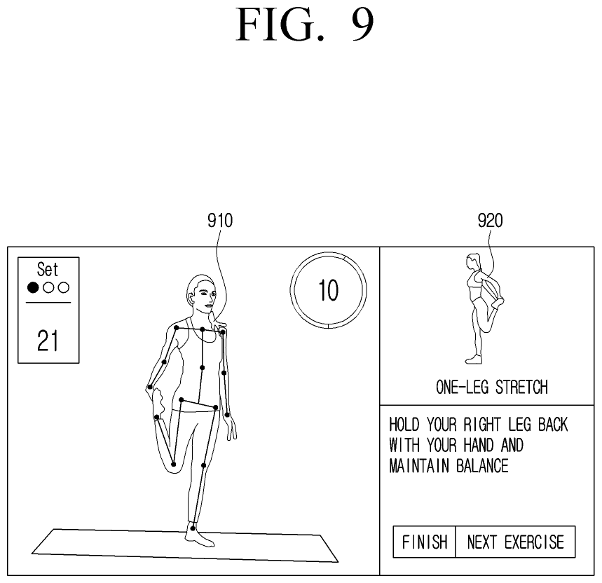

FIG. 9 is a diagram illustrating an operation in which the electronic apparatus 100 identifies user posture accuracy information by identifying a difference between an exercise posture included in the exercise information and the identified user posture according to an embodiment of the present disclosure.

Referring to FIG. 9, the processor 170 may acquire a skeleton image corresponding to the user posture based on the acquired user image, and may identify a difference between the user posture and a basic exercise posture by comparing the acquired skeleton image with a basic skeleton image included in the exercise information.

If the identified difference is greater than or equal to the predetermined value (S840—Y), the processor 170 may acquire an exercise list excluding an exercise currently performed by the user (S850). That is, if the difference between the exercise posture included in the exercise information and the identified user posture is greater than or equal to the predetermined value, the processor 170 may identify the corresponding exercise as excessively difficult and may provide the exercise list excluding the corresponding exercise.

In addition, if the identified difference is greater than or equal to the predetermined value (S840—Y), the processor 170 may identify a part of the user posture in which the difference from the basic exercise posture is greater than or equal to the predetermined value, and may control the display 130 or the speaker 140 to provide the user with user posture correction information for the corresponding part.

If the identified difference is less than the predetermined value (S840—N), the processor 170 may acquire an exercise list including the exercise currently performed by the user (S860).

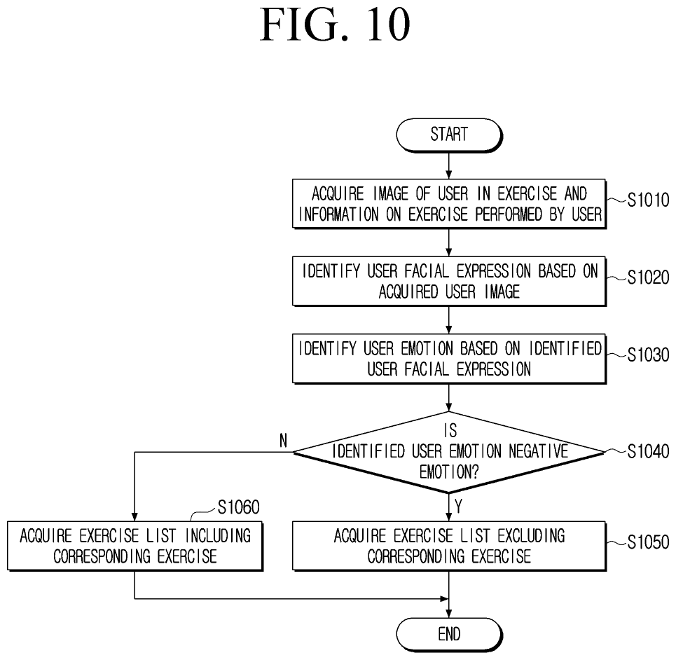

FIG. 10 is a flowchart illustrating an operation in which the electronic apparatus 100 provides the user with a customized exercise list based on the user expression according to an embodiment of the present disclosure.

Referring to FIG. 10, the processor 170 may acquire an image of the user in exercise and information on the exercise performed by the user (S1010).

The processor 170 may identify the user facial expression based on the acquired user image (S1020). The processor 170 may identify the user emotion based on the identified user facial expression (S1030). Here, the user emotion may be divided into positive emotions and negative emotions, or may be subdivided into emotions such as joy, relaxation, calmness, suffering, or tiredness.

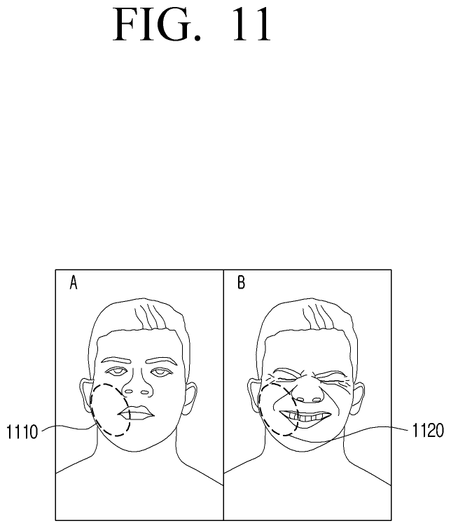

FIG. 11 is a diagram illustrating an operation in which the electronic apparatus 100 identifies the user expression according to an embodiment of the present disclosure.

Referring to FIG. 11, if the number of wrinkles included in one facial region of the user facial image is less than a predetermined value (1110), the processor 170 may identify the user emotion as a the positive emotion such as joy, relaxation, or calmness.

On the other hand, if the number of wrinkles included in one facial region of the user facial image is greater than or equal to the predetermined value (1110), the processor 170 may identify the user emotion as the negative emotion such as suffering or tiredness.

In addition, the processor 170 may input the user facial image into a user emotion identification model to thus acquire user emotion information based on the facial image.

In addition, the processor 170 may identify the emotion based on the user facial expression based on whether a change in one region of the identified user facial expression is greater than or equal to the predetermined value.

If the identified user emotion is the negative emotion (S1040—Y), the processor 170 may acquire the exercise list excluding the exercise currently performed by the user (S1050). That is, if the identified user facial expression represents the negative emotion such as suffering or tiredness, the processor 170 may identify that the exercise currently performed by the user is the exercise of excessively high difficulty, excessive strain, or likely to cause injury, and may provide the user with an exercise guide by acquiring the exercise list excluding such exercise and suggesting the same to the user.

If the identified user emotion is not a negative emotion (S1040—N), the processor 170 may acquire the exercise list including the exercise currently performed by the user (S1060). That is, if the identified user facial expression represents the positive emotion such as joy, relaxation, or calmness, the processor 170 may identify that the exercise currently performed by the user is suitable for the user at a current time, and may provide the user with an exercise guide by acquiring the exercise list including such exercise and suggesting the same to the user.

According to an embodiment, the processor 170 may identify the user heart rate during a predetermined time while the user exercises.

The processor 170 may perform the communication connection with a wearable device through the communication interface 110, and may receive heart rate sensing information during a predetermined time from the wearable device.

The processor 170 may acquire the exercise list excluding the exercise currently performed by the user if a difference between the user heart rate during the predetermined time and a reference heart rate for the exercise is greater than or equal to a predetermined value.

That is, if the user heart rate is excessively higher than the reference heart rate, the processor 170 may identify the exercise currently performed by the user as an excessively difficult or excessive exercise, and acquire the exercise list excluding the corresponding exercise.

In addition, if the user heart rate is excessively lower than the reference heart rate, the processor 170 may identify the exercise currently performed by the user as an excessively easy or ineffective exercise, and acquire the exercise list excluding the corresponding exercise.

As described above, the processor 170 may provide the user with the most suitable exercise list based on the user heart rate during the predetermined time.

According to an embodiment, the processor 170 may acquire the user exercise history information. Based on the acquired user exercise history information, the processor 170 may identify the exercise information skipped by the user. The processor 170 may acquire an exercise list excluding the exercise skipped by the user.

That is, the processor 170 may identify the exercise that the user usually skips and does not perform, and may provide the user with an optimal exercise routine by providing the exercise list excluding such an exercise.

According to an embodiment, the processor 170 may identify the physical information and exercise information of the user. The processor 170 may provide the exercise guide information based on the identified user physical information and the identified user exercise information.

Here, the user physical information may include the height, weight, gender, or age group of the user, and the exercise information may include exercise goal, exercise experience, number of exercises, body part to focus on, body part to be cautious about during exercise due to injury or the like, exercise ability test, or the like.

The processor 170 may receive input regarding the user physical information or the user exercise information in an out of box (OOB, initial setting stage) through the user interface 150.

In this process, the processor 170 may control the display 130 to output an image or a GUI guiding the user physical information or the user exercise information, and control the speaker 140 to output a voice guiding the user physical information or the user exercise information.

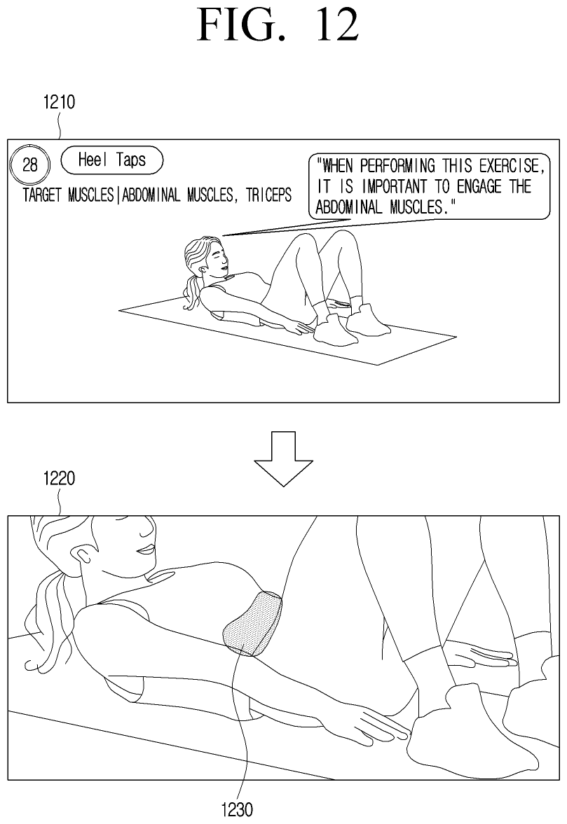

FIG. 12 is a diagram illustrating an operation in which the electronic apparatus 100 provides an animation effect emphasizing information on at least one of a main description or a main body part in a video according to an embodiment of the present disclosure.

Referring to FIG. 12, if the exercise guide information is provided as a video 1210, the processor 170 may identify at least one of the main description or the main body part in the video. Here, the main description may be a description of a key operation of the exercise or a description of breathing, the main body part may be a user body part trained through the exercise, and the present disclosure is not limited thereto.

The processor 170 may provide an animation effect 1220 or 1230 emphasizing the information on at least one of the identified main description or the identified main body part. The animation effect may be enlargement 1220 of a region, displaying an indicator 1230 in a region, displaying a highlight color in a region, displaying guide text in a region, or the like, and is not limited thereto.

In addition, the processor 170 may control the speaker 140 to provide an audio effect emphasizing the information on at least one of the identified main description or the identified main body part. In detail, the processor 170 may output a voice by increasing a volume of a section corresponding to an instructor's utterance related to contents of the identified main description or the identified main body part compared to the other sections.

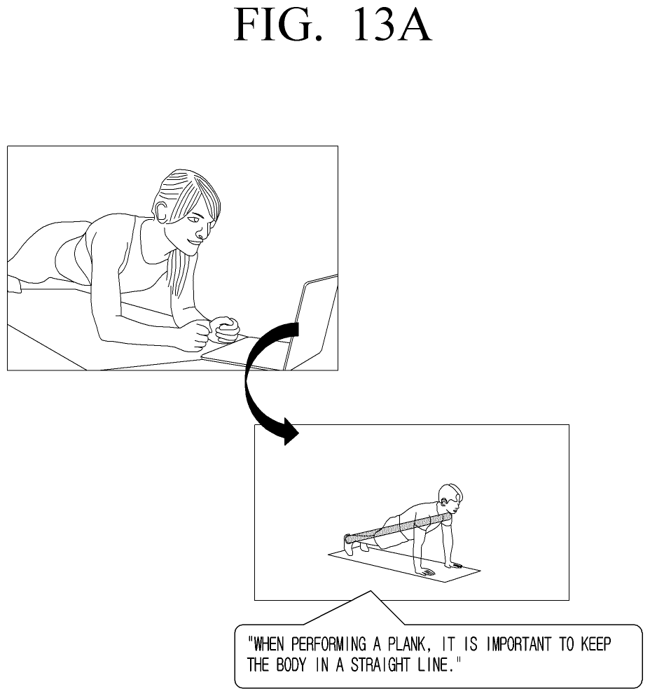

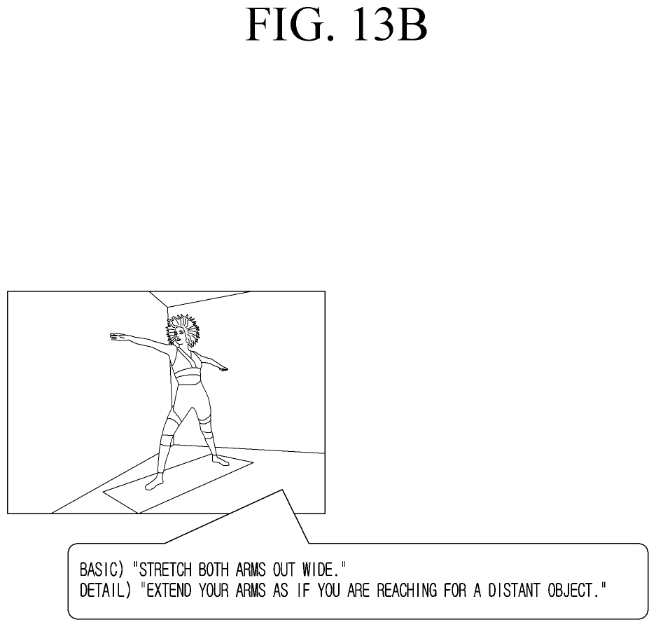

FIGS. 13A and 13B are diagrams illustrating an operation in which the electronic apparatus 100 provides the exercise guide information based on at least one of a user motion or the user gaze according to an embodiment of the present disclosure.

Referring to FIG. 13A, the processor 170 may identify at least one of the motion or gaze of the user in exercise, and provide the exercise guide information based on at least one of the identified user motion or the identified user gaze.

In detail, the processor 170 may control the display 130 to output the content or feedback information to a point corresponding to the user gaze direction based on at least one of the motion or gaze of the user in exercise, and may control the speaker 140 to output a voice guide.

Referring to FIG. 13B, if the gaze of the user in exercise does not face the display device, the processor 170 may control the speaker 140 to output the voice guide.

However, the present disclosure is not limited thereto, and the processor 170 may control the display 130 or the speaker 140 to provide the user with the content or feedback information in various ways based on the user motion and the user gaze.

The electronic apparatus 100 according to the present disclosure may be implemented as a single electronic apparatus 100, or may also be implemented as a system including a plurality of electronic apparatuses 100.

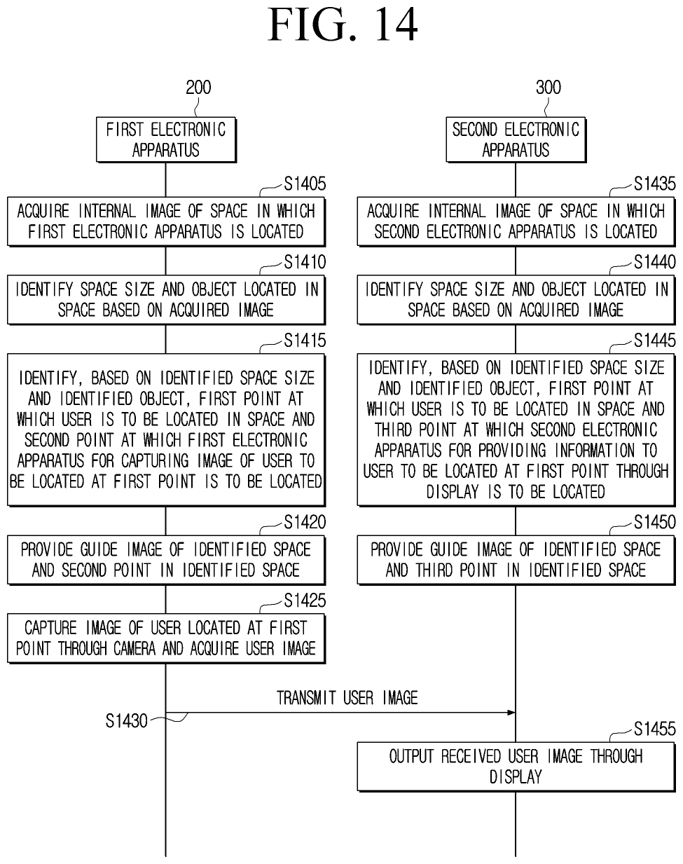

FIG. 14 is a sequence diagram illustrating a system including a first electronic apparatus 200 and a second electronic apparatus 300 for providing the user with the exercise feedback information according to an embodiment of the present disclosure.

Referring to FIG. 14, the first electronic apparatus 200 may acquire an internal image of a space in which the first electronic apparatus 200 is located (S1405).

The first electronic apparatus 200 may identify a space size and an object located in the space based on the acquired image (S1410).

The first electronic apparatus 200 may identify, based on the identified space size and the identified object, a first point at which the user is to be located in the space and a second point at which the first electronic apparatus 100 for capturing an image of the user to be located at the first point is to be located (S1415).

The first electronic apparatus 200 may provide a guide image of the identified space and the second point in the identified space (S1420).

The first electronic apparatus 200 may acquire a user image by capturing the image of the user located at the first point through the camera 120 (S1425).

The first electronic apparatus 200 may perform a communication connection with the second electronic apparatus 300 through the communication interface 110, and transmit the acquired user image (S1430).

The second electronic apparatus 300 may identify the space size and the object located in the space based on the acquired image (S1435).

The second electronic apparatus 300 may identify, based on the identified space size and the identified object, the first point at which the user is to be located in the space and the second point at which the first electronic apparatus 100 for capturing an image of the user to be located at the first point is to be located (S1440).

The second electronic apparatus 300 may identify, based on the identified space size and the identified object, a third point at which the second electronic apparatus 100 for providing information to the user to be located at the first point through the display 130 is to be located (S1445).

The second electronic apparatus 300 may provide a guide image of the identified space and the third point in the identified space (S1450).

The second electronic apparatus 300 may perform a communication connection with the first electronic apparatus 200, and output the received user image through the display 130 (S1455).

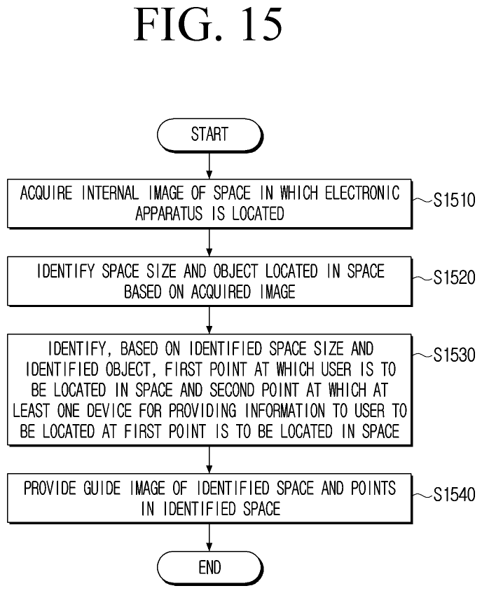

FIG. 15 is a flowchart illustrating an operation of an electronic apparatus 100 according to an embodiment of the present disclosure.

Referring to FIG. 15, the electronic apparatus 100 may acquire an internal image of a space in which the electronic apparatus 100 is located (S1510). The processor 170 may identify a space size and an object located in the space based on the acquired image (S1520). Here, the object may be an exercise device, furniture, or an electronic device located in the space, and is not limited thereto.

The processor 170 may identify, based on the identified space size and the identified object, a first point at which the user in exercise is to be located in the space and a second point at which at least one device for providing feedback information to the user to be located at the first point is to be located in the space (S1530).

Here, the second point may include at least one of a third point at which the display device is to be located in the space and a fourth point at which the camera 120 is to be located, and the processor 170 may identify at least one of the third point or the fourth point based on the identified space size and the location of the identified first point.

In addition, the processor 170 may provide an exercise guide suggesting the number of cameras 120 to be located at the third point or the number of display devices to be located at the fourth point based on the exercise information and the user personal information.

The processor 170 may provide a guide image of the identified space and the points in the identified space (S1540).

As described above, the electronic apparatus 100 according to the present disclosure may guide the method for setting at least one device for providing the user with the exercise feedback information, and may provide the user with the exercise feedback information based on the user personal information and the user exercise information.

According to an embodiment, the methods according to the various embodiments disclosed in the disclosure may be included and provided in a computer program product. The computer program product may be traded as a commodity between a seller and a purchaser. The computer program product may be distributed in a form of the machine-readable storage medium (e.g., a compact disc read only memory (CD-ROM)), or may be distributed online (e.g., by download or upload) via an application store ((e.g., PlayStore™) or directly between two user devices (e.g., smartphones). In case of the online distribution, at least a part of the computer program product (e.g., downloadable app) may be at least temporarily stored or temporarily provided in the machine-readable storage medium such as the memory of a manufacturer server, an application store server, or a relay server.

Although the embodiments are shown and described in the present disclosure as above, the present disclosure is not limited to the above-described specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
memory storing at least one instruction; and
at least one processor,
wherein the at least one instruction, when executed by the at least one processor, individually or collectively, causes the electronic apparatus to:
obtain an internal image of a space in which the electronic apparatus is located;
identify a space size and an object located in the space based on the internal image;
identify, based on the space size and the object, a plurality of points comprising a first point at which a user in exercise is to be located in the space, and a second point at which at least one device for providing feedback information to the user to be located at the first point is to be located in the space; and
provide a guide image of the space and the plurality of points in the space.

2. The electronic apparatus as claimed in claim 1, wherein the second point comprises at least one of a third point at which a display device is to be located in the space or a fourth point at which a camera is to be located, and
wherein the at least one instruction, when executed by the at least one processor individually or collectively, causes the electronic apparatus to identify at least one of the third point or the fourth point based on the space size and a location of the first point.

3. The electronic apparatus as claimed in claim 2, wherein the at least one instruction, when executed by the at least one processor individually or collectively, causes the electronic apparatus to:
identify a posture of the user to be located at the first point;
identify a gaze direction of the user based on the posture of the user; and
identify, as the third point, a point corresponding to the gaze direction of the user.

4. The electronic apparatus as claimed in claim 2, wherein the at least one instruction, when executed by the at least one processor individually or collectively, causes the electronic apparatus to:
identify a posture of the user to be located at the first point; and
identify, as the fourth point, a point at which an entire body of the user is capable of being captured, based on the space size, the location of the first point, and the posture of the user.

5. The electronic apparatus as claimed in claim 2, wherein the at least one instruction, when executed by the at least one processor individually or collectively, causes the electronic apparatus to:
identify a size of free space available to the user located at the first point based on the space size, the object located in the space, and the location of the first point; and
provide an exercise guide based on the size of the free space.

6. The electronic apparatus as claimed in claim 1, wherein the at least one instruction, when executed by the at least one processor individually or collectively, causes the electronic apparatus to transmit, to the at least one device located at the second point, a control signal for an image capturing operation or an image display operation of the at least one device, based on at least one of the space size, the object, a posture of the user located at the first point, or a gaze direction of the user located at the first point,
the control signal for the image capturing operation indicating at least one of a capturing angle, a capturing range, a magnification, or a capturing brightness, and
the control signal for the image display operation indicating at least one of a display angle, a size of content to be displayed, a ratio of regions in the content to be displayed, or a display brightness.

7. The electronic apparatus as claimed in claim 1, wherein the at least one instruction, when executed by the at least one processor, individually or collectively causes the electronic apparatus to transmit, to the at least one device located at the second point, a signal to cause an operation performed by the at least one device to be changed if at least one of a location of the user or a posture of the user in the space changes.

8. The electronic apparatus as claimed in claim 1, wherein the at least one instruction, when executed by the at least one processor, individually or collectively causes the electronic apparatus to:
obtain an image of the user in exercise and information on the exercise performed by the user;
identify a posture of the user based on the image of the user;
identify a difference between an exercise posture included in exercise information and the posture of the user; and
provide exercise guide information based on the difference.

9. The electronic apparatus as claimed in claim 8, wherein the at least one instruction, when executed by the at least one processor individually or collectively, causes the electronic apparatus to obtain an exercise list excluding the exercise if the difference is greater than or equal to a predetermined value.

10. The electronic apparatus as claimed in claim 1, wherein the at least one instruction, when executed by the at least one processor individually or collectively, causes the electronic apparatus to:
obtain an image of the user in exercise and information on the exercise performed by the user;
identify a facial expression of the user based on the image of the user; and
provide exercise guide information based on the information on the exercise and the facial expression.

11. The electronic apparatus as claimed in claim 10, wherein the at least one instruction, when executed by the at least one processor individually or collectively, causes the electronic apparatus to:
identify an emotion of the user based on the facial expression; and
obtain an exercise list excluding the exercise if the emotion is a negative emotion.

12. The electronic apparatus as claimed in claim 1, wherein the at least one instruction, when executed by the at least one processor individually or collectively, causes the electronic apparatus to:
identify a heart rate of the user in exercise for a predetermined time; and
acquire an exercise list excluding the exercise if a difference between the heart rate during the predetermined time and a reference heart rate for the exercise is greater than or equal to a predetermined value.

13. The electronic apparatus as claimed in claim 1, wherein the at least one instruction, when executed by the at least one processor individually or collectively, causes the electronic apparatus to:
identify exercise information skipped by the user; and
acquire an exercise list excluding the exercise.

14. The electronic apparatus as claimed in claim 1, wherein the at least one instruction, when executed by the at least one processor individually or collectively, causes the electronic apparatus to:
identify physical information of the user and exercise information of the user; and
provide exercise guide information based on the physical information and the exercise information;
identify at least one of a main description or a main body part in a video if the exercise guide information is provided as the video; and
display an animation effect emphasizing information on at least one of the main description or the main body part.

15. A control method of an electronic apparatus comprising:
obtaining an internal image of a space in which the electronic apparatus is located;
identifying a space size and an object located in the space based on the internal image;
identifying, based on the space size and the object, a plurality of points comprising a first point at which a user in exercise is to be located in the space and a second point at which at least one device for providing feedback information to the user to be located at the first point is to be located in the space; and
providing a guide image of the space and the plurality of points in the space.

16. The control method as claimed in claim 15, wherein the second point comprises at least one of a third point at which a display device is to be located in the space or a fourth point at which a camera is to be located, and
wherein the identifying the plurality of points comprises identifying at least one of the third point or the fourth point based on the space size and a location of the first point.

17. The control method as claimed in claim 16, wherein the identifying the plurality of points comprises:
identifying a posture of the user to be located at the first point;
identifying a gaze direction of the user based on the posture of the user; and
identifying, as the third point, a point corresponding to the gaze direction of the user.

18. The control method as claimed in claim 16, wherein the identifying the plurality of points comprises:
identifying a posture of the user to be located at the first point; and
identifying, as the fourth point, a point at which an entire body of the user is capable of being captured, based on the space size, the location of the first point, and the posture of the user.

19. The control method as claimed in claim 16, further comprising:
identifying a size of free space available to the user located at the first point based on the space size, the object located in the space, and the location of the first point; and
providing an exercise guide based on the size of the free space.

20. A non-transitory computer-readable recording medium having at least one instruction recorded thereon, that, when executed by at least one processor, individually or collectively, causes the at least one processor to:
obtain an internal image of a space in which an electronic apparatus is located;
identify a space size and an object located in the space based on the internal image;
identify, based on the space size and the object, a plurality of points comprising a first point at which a user in exercise is to be located in the space, and a second point at which at least one device for providing feedback information to the user to be located at the first point is to be located in the space; and
provide a guide image of the space and the plurality of points in the space.
